(19) United States
(12) Patent Application Publication
(10) Pub. No.: US 2025/0019121 A1
(43) Pub. Date: Jan. 16, 2025

(54) WATER LEVEL METER FOR HYDRATION PACKS

(71) Applicant: FOSSIL OUTDOOR INC., Phoenix, AZ (US)

(72) Inventor: Everett Jesse, Scottsdale, AZ (US)

(21) Appl. No.: 18/904,362

(22) Filed: Oct. 2, 2024

Related U.S. Application Data
(63) Continuation-in-part of application No. 17/194,010, filed on Mar. 5, 2021, now Pat. No. 12,145,834.

(51) Int. Cl. B65D 25/20

(52) U.S. Cl. CPC B65D 25/20; B65D 2203/04; B65D 2203/10

(57) ABSTRACT

An apparatus and method that monitors the consumption of a beverage containing vessel, while the vessel is contained in a pack, bag, or pocket. The method for monitoring includes a sensor that collects data on the beverage withing the vessel, including initial fluid levels. The data may be broadcast to other devices where the data is analyzed to generate information, and it is displayed. The apparatus may consist of a battery, battery circuit, sensor circuit, temporary storage, sensor, and antenna. The initial fluid level may be determined by the sensor or a third party prior to use by the sensor circuit. Information created may include a warning of when the vessel will be empty relative to the activity of the user.

### CROSS-REFERENCE TO RELATED APPLICATIONS

This application is a continuation in part of and claims the benefit of U.S. application Ser. No. 17/194,010 filed on Mar. 5, 2021. The entire disclosure of the above application is incorporated herein by reference

### FIELD

The present technology relates to liquid level metering, and particularly to beverage liquid levels carried on one's person.

### BACKGROUND ART

It is known in the prior art water level meters have existed for as long as water level storage has existed. Initially this was done by making charcoal or other markings on the side of natural water basins. Water level detection has expanded to nearly every form of storage vessel. Many containers have hash marks on them and are translucent which allows users to see the level. More advanced detection equipment has been developed to make liquid level detection easier. Advanced level detection equipment uses electronic sensors which can report the water level electronically to computers.

Outdoor enthusiasts, law enforcement, fire fighters, and military members frequently use hydration equipment during activities and operations. This hydration equipment uses a pack of to hold a vessel containing a beverage. The vessel may be flexible. The pack may be mounted in numerous configurations and positions on the human body.

The only way to know how much water remains in the vessel is to remove the pack and check it manually by eye or touch. Checking the water level requires activity to be stopped. Users may be unable to stop their activity to check their beverage level or may simply forget. Not being able to check water levels in the packs during activity may put the user in a life-threatening position. The first indication they have ran out of water is they are out of water.

The advantage of using the proposed invention include:

Avoidance of life-threatening situation—this invention is intended to provide warning for individuals who are using vessels in packs, so they do not run out of beverages without making the appropriate preparations to be replenished or rehydrated.

Improvement of athletic performance—having a better understanding of how much water is consumed during an activity allows the user to optimize consumption.

Identify point of no return—users can identify when they are down to a specified water level and can identify a maximum distance they can travel or work before they need to refill.

Improving cognitive performance—by cross referencing data with third party technology, hydration levels are optimized to ensure that cognitive performance is improved.

### SUMMARY OF EMBODIMENTS

In concordance with the instant disclosure, the product collects data relating to beverage consumption, then broadcasts it to a smart device to easily see.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations and are not intended to limit the scope of the present disclosure.

FIG. 1 illustrates the apparatus when it is placed between the vessel and the mouthpiece.

FIG. 2 illustrates the apparatus when it is placed on the exterior of the vessel.

FIG. 3 illustrates the apparatus when it is placed on the interior of the vessel.

FIG. 4 illustrates the mechanical process of how the apparatus works.

FIG. 5 illustrates the process for reporting data collected by the apparatus and transitioning it to actionable information.

FIG. 6 illustrates the process for determining the initial fluid level of the apparatus.

### DETAILED DESCRIPTION OF SPECIFIC EMBODIMENTS

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, all compositional percentages are by weight of the total composition, unless otherwise specified. Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

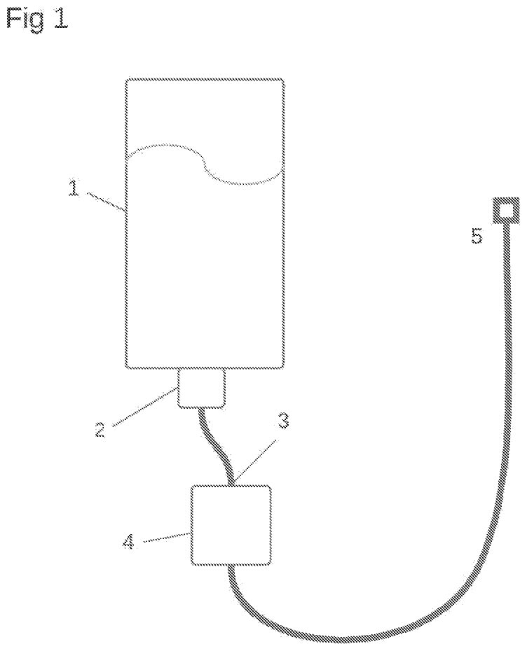

There are several embodiments which accomplish the objective of the product; however, the first embodiment which is illustrated in FIG. 1. is the best. This is due to the type of vessels which are common in packs and problems they cause for sensors.

Embodiment 1—The first embodiment uses a sensor which may contact the beverage or may be contactless. The sensor may sense the amount of water that passes from the apparatus. FIG. 1: illustrates how this may work in relation to the vessel 1.

The vessel used in packs may be made from a flexible material which like polyurethane; this means that the vessel is susceptible to shape changes from outside forces. An example of this would-be backpacking supplies which are being stored in a backpack with the vessel pressing up against backpacking supplies. The vessel is also susceptible to shape changes as the beverage is consumed and internal pressure causes it to collapse in on itself. The term “vessel” includes a hydration vessel.

The vessel has a fitting 2 where the beverage is conducted out of the vessel for consumption. The fitting may have a straw 3 which delivers the beverage to a mouthpiece 5 where the beverage is delivered for consumption.

The apparatus is installed between the fitting and the mouthpiece. It may be installed at a convenient location along the length of the straw.

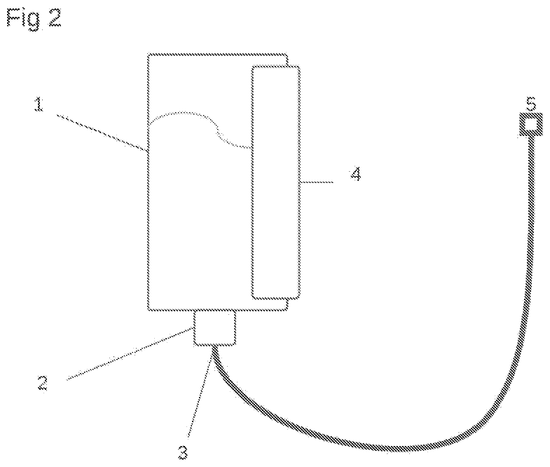

Embodiment 2—the second-best embodiment is illustrated in FIG. 2. It utilizes contactless sensor(s) which are mounted directly to the vessel 1. These sensors may have difficulty reading the liquid level of the beverage due to the changing shape of the vessel.

Similar to the first embodiment the vessel will have a fitting 2 where the beverage is conducted out of the vessel for consumption. The fitting may have a straw 3 which delivers the beverage to a mouthpiece 5 where the beverage is delivered for consumption.

Consider Embodiment 2 the apparatus 4 is fixed to the side of the container and uses contactless sensors to identify where the beverage is located within the container.

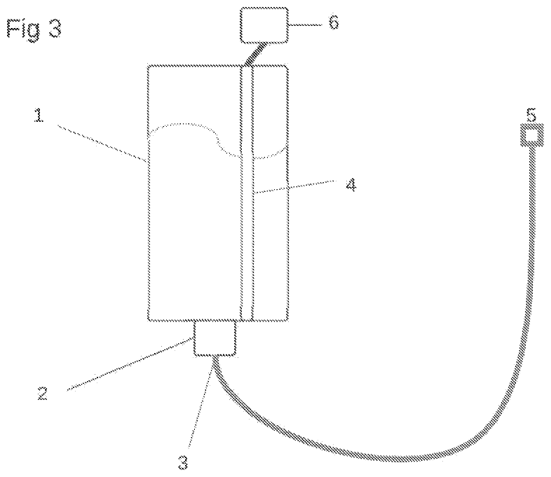

Embodiment 3—the least effective method is illustrated in FIG. 3. It utilizes sensor(s) which come into direct contact with the beverage while inside the vessel 1. These sensors are the types used as liquid level meters. They are excellent for detecting the liquid level when the vessel holding that liquid is a static shape. For example, a gas tank, water tank, or reservoir all are vessels which remain in a static shape. Using this method may cause a great inconvenience in regard to maintaining (keeping clean) the apparatus and vessel.

Similar to the first two embodiments the vessel will have a fitting 2 where the beverage is conducted out of the vessel for consumption. The fitting may have a straw 3 which delivers the beverage to a mouthpiece 5 where the beverage is delivered for consumption.

In Embodiment 3 the apparatus is in two parts the first part 4 is fixed to the inside of the vessel and contains sensors which contact the beverage to identify where the beverage is located within the vessel. The second part 6 is on the outside of the container and may have a wired or wireless connection to the apparatus within the vessel. The second part will be used to broadcast data observed by the sensors on the inside of the vessel.

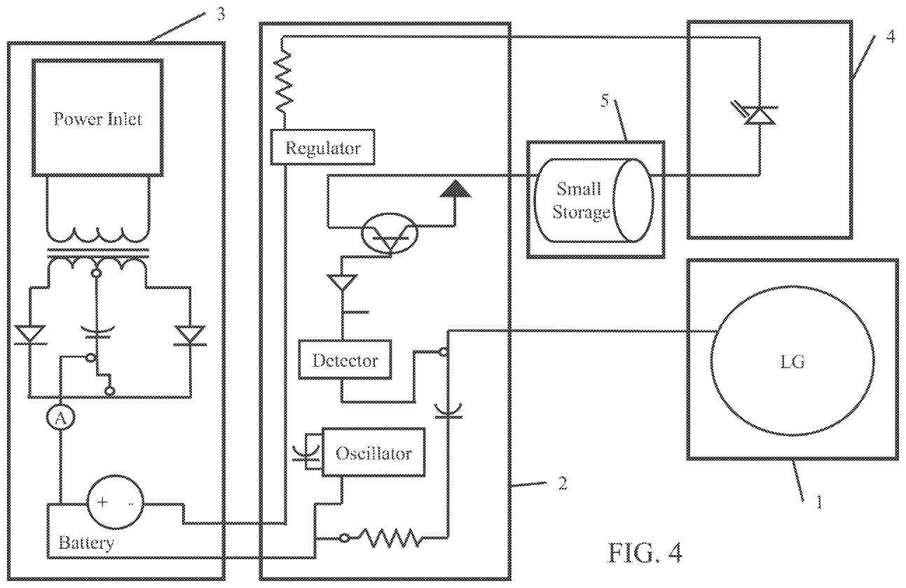

Mechanical Process—Each of the embodiments have the same general form of construction. This form of construction is illustrated in FIG. 4. The constructed apparatus may be in a single housing or in several housings as it is suggested in Embodiment 3. Regardless of how many housings there are there should be the same components throughout each of the embodiment systems. These parts include a sensor 1, a sensor circuit 2, a battery and/or battery charging circuit 3, and a broadcast antenna 4.

The sensors described above may include flow sensors, float sensors, ultrasonic sensors, light sensors, motion sensors, and radiation sensors.

The sensor circuit may resemble the one illustrated in FIG. 4. 2. The sensor circuit may change within the specifications of the sensor manufacture.

The battery or battery charge circuit may resemble the one illustrated in FIG. 4. 3. The battery or battery charge circuit may change depending on the specifications set by the sensor manufacturer, the antenna manufacturer, the battery manufacturer, and/or the charger manufacturer.

The battery charge circuit may be eliminated leaving only the battery circuit.

The antenna broadcast a wireless signal transmitting the recorded data.

Embodiments may also include temporary data storage drive 5 within apparatus.

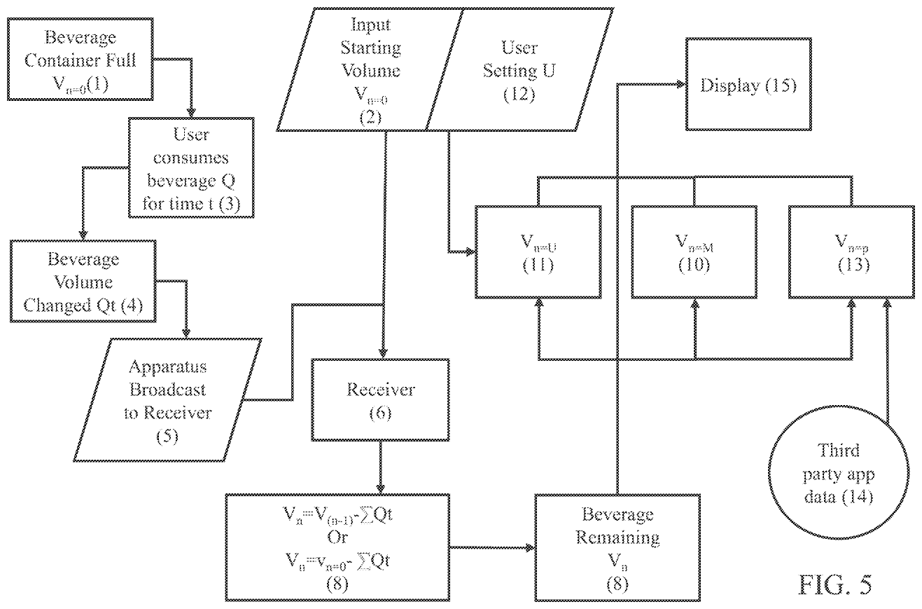

Process of reporting FIG. 5 separated the apparatus from traditional level meters which merely report fluid levels. This process adapts the collected information to uniquely suit beverage consumption, as it relates to survival and improved performance.

Collection of initial input—this may be done automatically 1 by allowing sensor to report initial fluid level. It may also be done manually 2 by the user inputting the starting volume. In either case initial Volume is denoted by Vₙ₌₀. The term “initial input” may include an initial fluid level.

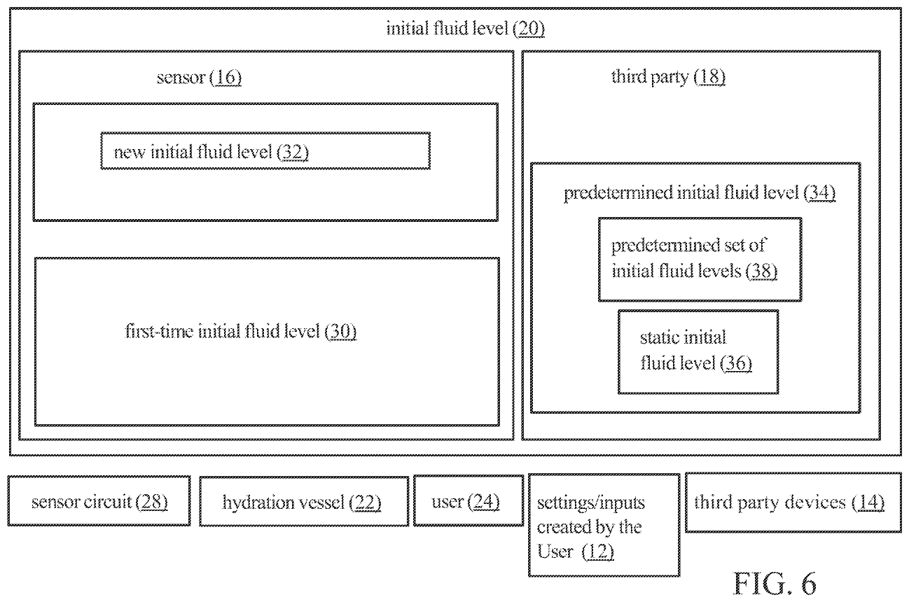

With reference to FIG. 6, the sensor 16 may be configured to automatically determine the initial fluid level 20 within a hydration vessel 22 prior to each use. When the hydration vessel 22 is filled by the user 24, the sensor 16 may determine the initial fluid level 20 and report the initial fluid level 20 to the sensor circuit 28. When the user 24 drinks from the hydration vessel 22, the sensor 16 may determine a subsequent fluid level and provide the subsequent fluid level to the sensor circuit 28. When the user 24 refills the hydration vessel 22, the sensor 16 may automatically determine a new initial fluid level 32. The sensor 16 may then report the new initial fluid level 32 to the sensor circuit 28 for calculating the fluid volume within the hydration vessel 22 based on the new initial fluid level 32 and any subsequent fluid levels reported by the sensor 16 to the sensor 16 circuit 28 after the new initial fluid level 32 is determined.

The sensor 16 may also be configured to determine a first-time initial fluid 30 level within the hydration vessel 22 prior to the first time that the user 24 drinks from the hydration vessel 22. The sensor 16 may report the first-time initial fluid 30 level to the sensor circuit 28, and the sensor circuit 28 may broadcast the first-time initial fluid 30 level to the broadcast antenna. When the user 24 drinks from the hydration vessel 22, the sensor 16 may determine a subsequent fluid level and may provide the subsequent fluid level to the sensor 16 circuit 28. When the user 24 refills the hydration vessel 22, the sensor 16 may report the first-time initial fluid 30 level again, and not determine a new initial fluid level 32. The sensor 16 may be configured to repeatedly report the first-time initial fluid 30 level to the sensor circuit 28. Alternatively, the sensor 16 may be configured to report the first-time initial fluid 30 level only once to the sensor circuit 28, and the user 24 refills the hydration vessel 22, the sensor 16 may report to the sensor circuit 28 only that the hydration vessel 22 is refilled.

As shown in FIG. 6, the sensor 16 may also be configured so that a third party 18 may calibrate the sensor 16 with a predetermined initial fluid level 34 prior to user 24 drinking from the hydration vessel 22. A third party 18 may include a manufacturer, retail seller, wholesaler, distributor, or authorized entity that manufactures, sells, carries, ships, or refurbishes a product that includes a hydration vessel 22 coupled with the sensor 16 and sensor circuit 28 or includes third party devices 14 in electronic communication with sensor 16. The sensor 16 may be calibrated by the third party 18 selecting from a range of initial fluid levels 20 depending on the desired use of the hydration vessel 22 or anticipated physical activities of the user 24. For example, a third party 18 may calibrate the sensor 16 to include a predetermined initial fluid level 34 based on a customer's anticipated athleticism, frequent distances travelled, biometrics, dietary restrictions, medications, disease data, or sleep data. A third party 18 may calibrate the sensor 16 to report a static initial fluid level 36, where the initial fluid level remains the same regardless of settings/inputs created by the User 12. Alternatively, a third party 18 may calibrate the sensor 16 to dynamically report a predetermined set of initial fluid levels 38 based on settings/inputs created by the User 12 such as activities, biometrics, previous beverage consumption, previous calorie consumption, stress levels, or location. However, one skilled in the art can employ other configurations of the sensor 16 to accommodate the commercial needs of a third party 18, as designed. It should be appreciated that third party 18 determination of the initial fluid level 20 enhances the versatility of hydration vessels 22 and provides a wide range of options for third parties to customize hydration vessel 22 products to their specific brand, clientele, design requirements.

In each configuration of the sensor 16 discussed above, the initial fluid level 20 may be unalterable. For example, if the sensor 16 is configured to determine the initial fluid level 20 after each use, the user 24 cannot alter the initial fluid level 20 or re-use an initial fluid level 20 determined from a previous fill of the hydration vessel 22. In another example, if the sensor 16 is configured to determine a first-time initial fluid 30 level only, the user 24 cannot alter the first-time initial fluid 30 level by refilling the hydration vessel 22. In yet another example, if the initial fluid level 20 is predetermined by a third party 18, the user 24 cannot alter the initial fluid level 20 by changing settings or inputs on an electronic device in communication with the sensor 16. An electronic device may include the device software, including settings/inputs created by the User 12, a smart phone, a smart watch, a tablet, a desktop, and any software applications, third party devices 14, or cloud-based software applications. One of ordinary skill in the art may employ various levels of access for a user 24 to alter the initial fluid levels 20 depending on settings/inputs created by the User 12, or third party 18 preferences.

Beverage is then consumed 3 represented by volumetric flow rate (Q) multiplied by time (t) which equals the change in volume ΔV. Q is the volumetric flow rate defined by Q=vA where v=flow velocity and A=cross sectional vector area/surface. Change in volume may also be ΔV=x₁-x₂ where x₁ is the previous sensor reading and x₂ is the current sensor reading.

After consumption of the beverage the initial level Vₙ₌₀ is now changed to Vₙ 4. The apparatus must solve for Vₙ.

The apparatus will then broadcast Qt 5 or store Qt on the temporary data storage as described above from FIG. 4.5. If there is no Q then there is no broadcast.

Qt is then received by a device 6 via the broadcast from the apparatus. The device will also receive any manual input from the user. The receiver receives data as Qt, Vₙ₌₀, or Vₙ.

The device must solve for Vₙ 8. If no Qt or Vₙ is received from the broadcast, then the equation default is:

Vₙ=Vₙ₌₀

If no Qt is received but a new Vₙ is received that does not equal the previous Vₙ, then the previous Vₙ becomes Vₙ₋₁ and the following equation is used to solve for Vₙ:

$${V}_{n} = {v}_{( n - 1 )}$$

If Qt is received it cancels out any previous Vₙ or Vₙ₌₀. When a Qt is received any Vₙ or Vₙ₌₀ now becomes V₍ₙ₋₁₎ and the following equation is used to solve for Vₙ:

$${V}_{n} = {V}_{( n - 1 )} - \sum Qt$$

$$or$$

$${V}_{n} = {V}_{( n - 1 )} - \sum Qt$$

A newly found Vₙ 9 is then recorded within the device software. The new Vₙ is displayed to the user via the display 15 or is used to create additional outputs.

There would be three types of modifications that may be made to Vₙ which will then be reported through a display.

A modification may include V_{n=M} 10 which are modification crated based on presets that are within the device software.

A modification may include V_{n=U} 11 which are modifications which are influenced by settings/inputs created by the User 12. These inputs may include distance travelled, activity start time, calories burned, calories consumed, average heart rate, heart rate, body weight, body weight over time, altitude, outside temperature, body temperature, wellbeing indicator, previous beverage consumption, previous calorie consumption, stress levels, sweat rate, barometric data, regional data, location, age, height, sex, medications, disease data, sleep data and so on.

A modification may include V_{n=P} 13 which are modifications that are influenced by inputs from third party devices 14. These inputs received from third party devices may include distance travelled, activity start time, calories burned, calories consumed, average heart rate, heart rate, body weight, body weight over time, altitude, outside temperature, body temperature, wellbeing indicator, previous beverage consumption, previous calorie consumption, stress levels, sweat rate, barometric data, regional data, location, age, height, sex, medications, disease data, sleep data and so on.

Display/Notify 15 the display or notification communicating the data and information may be through visual display on a smartphone, tv, monitor, wearable device, small device display. The data and information may also be transmitted through sound, bioimplants or haptics.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods may be made within the scope of the present technology, with substantially similar results.

What is claimed is:

1. An apparatus configured for use with a hydration vessel, the apparatus comprising:
a sensor configured to:
determine an initial fluid level within the hydration vessel;
a sensor circuit configured to:
receive the initial fluid level of the hydration vessel from the sensor;
a broadcast antenna configured to:
receive the initial fluid level from the sensor circuit,
transmit the initial fluid level to an electronic device; and
a power supply configured to provide power to the sensor, the sensor circuit, and the broadcast antenna.

2. The apparatus of claim 1, wherein the initial fluid level is a value predetermined by a third party and the sensor determines the initial fluid level using the value predetermined by the third party.

3. The apparatus of claim 2, wherein the initial fluid level is unalterable.

4. The apparatus of claim 1, wherein the sensor is configured to determine a first-time initial fluid level within the hydration vessel and the sensor circuit is configured to receive and broadcast the first-time initial fluid level each time the hydration vessel receives a fluid.

5. The apparatus of claim 4, wherein the first-time initial fluid level is unalterable.

6. The apparatus of claim 1, wherein the sensor is configured to determine the initial fluid level within the hydration vessel each time the hydration vessel receives a fluid.

7. The apparatus of claim 6, wherein the initial fluid level determined by the sensor prior to each use is unalterable.

8. A method of using an apparatus with a hydration vessel, the method comprising:
providing an apparatus configured for use with a hydration vessel according to claim 1; and
receiving a fluid within the hydration vessel;

9. The method of claim 8, wherein the initial fluid level is a value predetermined by a third party and the sensor determines the initial fluid level using the value predetermined by the third party.

10. The method of claim 8, further comprising providing a value predetermined by a third party as the initial fluid level, wherein the sensor determines the initial fluid level using the value predetermined by the third party.

11. The method of claim 8, wherein the initial fluid level is a first-time initial fluid level, the sensor determines a first-time initial fluid level within the hydration vessel, and the sensor circuit receives and broadcasts the first-time initial fluid level each time the hydration vessel receives a fluid.

12. The method of claim 8, wherein the sensor determines the initial fluid level within the hydration vessel each time the hydration vessel receives a fluid.
